(19) United States
(12) Patent Application Publication
(10) Pub. No.: US 2002/0186833 A1
(43) Pub. Date: Dec. 12, 2002

(54) System and method of communicating via an in-band tone messaging protocol

(76) Inventor: Phillip W. Lucas, Plano, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 09/820,580

(22) Filed: Mar. 29, 2001

(51) Int. Cl. H04M 1/00; H04M 3/00

(52) U.S. Cl. 379/361

(57) ABSTRACT

A method of data communication which includes the steps of generating a first series of tones, the first series of tones encoding digital data in a predetermined message format, transmitting the first series of tones over a communication medium to a remote device, and then receiving a second series of tones, the second series of tones encoding a reply to the transmitted first series of tones, the reply being encoded digital data in the predetermined message format.

### TECHNICAL FIELD OF THE INVENTION

This invention relates to telecommunications equipment and processes, and more particularly, to a system and method of communicating via an in-band tone messaging protocol.

### BACKGROUND OF THE INVENTION

In-band multi-frequency tones such as DTMF (dual-tone multi-frequency) and MF (multi-frequency) have been used for dialing and conveying telephone number digits of the called party in telecommunications. DTMF tones generated by pressing telephone keypads have also been used in voice mail, voice response and other systems to issue user commands. MF is primarily used for in-network signaling. Typical telephone sets have 12 touchtone buttons (0-9, * and #), but government Autovon (automatic voice network) telephone sets have 16 buttons ((0-9, *, #, and A-D), where the additional buttons are used to signal urgency or precedence. The embodiment of the present invention described herein uses all 16 DTMF tones, but a 12-tone messaging protocol may also be formulated and employed.

Each DTMF digit is made up of a high frequency tone and a low frequency tone. The use of these tones over the telephony network has high reliability because the tones were specially selected to easily pass through the telephone network without attenuation and minimal interference with each other. DTMF is widely used and supported by all telephony carriers and wired and wireless telephony networks all over the world.

### SUMMARY OF THE INVENTION

Certain telecommunications devices have a data connection to the Internet such as DSL (digital subscriber loop) or cable modem as well as a voice or POTS (plain old telephone service) connection to the PSTN (public switched telephone network), such as the EVOLO™ system designed and manufactured by BROADBAND GATEWAYS™, INC. of Plano, Tex. There are instances where communication via the voice channel is preferred over the data channel, such as when the system is first installed. When such systems are first installed, certain system configuration is needed in order to bring the system up and running, including the data connection. The configuration process may include obtaining configuration data and setup parameters from a remote server. An ability to communicate and pass digital data such as the configuration and setup parameters over the POTS line using DTMF becomes an appealing alternative over other cumbersome possibilities.

In a device having a POTS connection and capability to generate in-band signals such as DTMF, digital data may be transmitted via the POTS line to a remote computer or device. In the present invention, a messaging protocol using in-band tone signaling is provided to transmit data over the voice channel.

In accordance with an embodiment of the present invention, a method of data communication which includes the steps of generating a first series of tones, the first series of tones encoding digital data in a predetermined message format, transmitting the first series of tones over a communication medium to a remote device, and then receiving a second series of tones, the second series of tones encoding a reply to the transmitted first series of tones, the reply being encoded digital data in the predetermined message format.

In accordance with another embodiment of the present invention, a communication method includes first dialing a predetermined destination address of a remote server. When there is a connection, a first series of tones are generated, which encodes data in a predetermined message format. The first series of tones are then transmitted over the connection to the remote server. A second series of tones are then received, which represent an acknowledge message in the predetermined message format.

In accordance with yet another embodiment of the present invention, a communication method includes dialing a predetermined destination address of a remote server and waiting for a POTS connection, generating a first series of DTMF tones, the first series of DTMF tones encoding digital data in a predetermined message format having a header, an opcode, and a checksum, and transmitting the first series of DTMF tones over the POTS connection to the remote server. A second series of DTMF tones are then received. The second series of DTMF tones encodes an acknowledge message, where the second series of DTMF tones are in the predetermined message format.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified block diagram of a client/server communication and messaging scheme according to the teachings of the present invention; and

FIG. 2 is a typical message flow diagram between a client and a server according to an embodiment of the present invention.

### DETAILED DESCRIPTION OF THE DRAWINGS

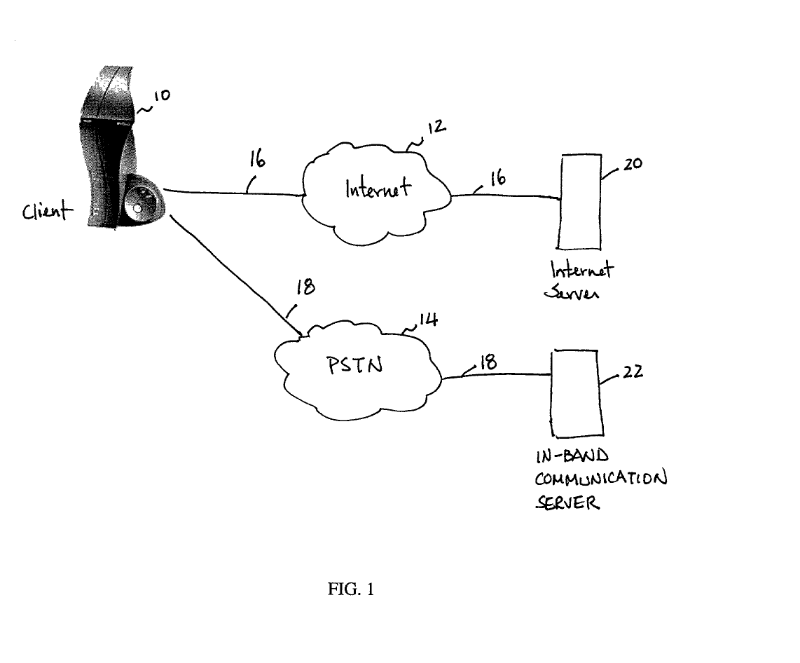

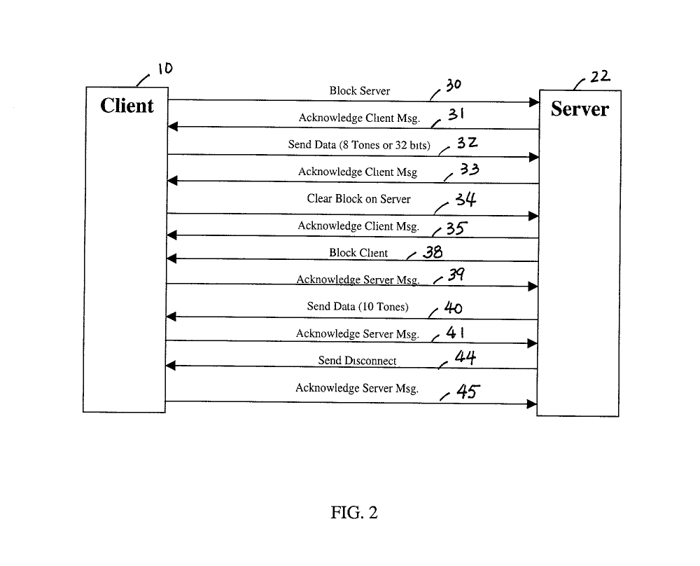

The preferred embodiment of the present invention and its advantages are best understood by referring to FIGS. 1 and 2 of the drawings, like numerals being used for like and corresponding parts of the various drawings.

FIG. 1 is a simplified block diagram of a client/server communication and messaging scheme according to the teachings of the present invention. A client device 10, such as the EVOLO™ system designed and manufactured by BROADBAND GATEWAYS™, INC. of Plano, Tex., is coupled to the Internet 12 and the PSTN (public switched telephone network) 14 via a data link 16 and a voice link 18, respectively. Data link 16 allows client device 10 to communicate with an Internet server 20 and voice link 18 allows client device 10 to communicate with an in-band communication server 22. Data link 16 may be a digital subscriber loop (DSL) connection, a cable modem connection, a satellite connection, or any other high-speed digital IP (Internet protocol) connection to the Internet. Voice link 18 is typically a POTS (plain old telephone service) line connected to the central office, a Class 5 switch, and other telephone network equipment. Either or both links 16 and 18 may be wired or wireless. Internet server 20 and in-band communication server 22 may be separate but co-located servers, separate servers remotely located from one another, or the same server serving both functions.

In an embodiment of the present invention, client device 10 includes a tone generator and a tone detector (not shown). More particularly, client device 10 is capable of generating and communicating digital data using a tone messaging protocol with in-band communication server 22 via voice link 18. Client device 10 is also capable of detecting and receiving the transmitted tones. Although any in-band tone signaling may be used, DTMF is the preferred system since it is reliably transmitted through the telephony network with minimum attenuation and interference. Furthermore, the apparatus for generating and detecting the DTMF tones is well known, compact and inexpensive.

The preferred embodiment of the present invention provides for communicating and transmitting digital data by using a DTMF messaging protocol. The 16 DTMF digits 0-9, A-D, * and # (E and F) are mapped to hexadecimal values as shown in TABLE A below. This mapping scheme allows each DTMF dual-tone to represent 4 bits (a nibble) of binary data. The “*” or “E” is used in an embodiment of the present invention as an escape tone to indicate that any tone followed by “E” should receive special processing. Furthermore, “F” is used to indicate the start of a new message.

TABLE A

| DTMF Tone(s) | Hex Equivalent Value |
|---|---|
| 0 | 0x0 |
| 1 | 0x1 |
| 2 | 0x2 |
| 3 | 0x3 |
| 4 | 0x4 |
| 5 | 0x5 |
| 6 | 0x6 |
| 7 | 0x7 |
| 8 | 0x8 |
| 9 | 0x9 |
| A | 0xA |
| B | 0xB |
| C | 0xC |
| D | 0xD |
| EE(**) | 0xE |
| EF(*#) | 0xF |

Each message is properly framed in order to facilitate error detection and recovery. The tones “E” and “F” are preferably set aside to provide framing and to indicate operation codes (opcodes) in the message body. Special exemplary DTMF code sequence or opcodes each has four tones and are listed in TABLE B below. An “X” in the table represent any of the possible tones “0” through “F”.

TABLE B

| DTMF | |
|---|---|
| Opcodes | Meaning |
| FFFF (####) | Header - indicates the start of a message |
| EAXX | Acknowledge Server Message (returns checksum in |
| | acknowledged server message) |
| EB0Y | Error found in Client Message - Y may be errors 0-F |
| EB1Y | Error found in Server Message - Y may be errors 0-F |
| EBC0 | Server informs Client that the Server is ready to receive |
| | data. |
| EBCY | Server requests Client to wait Y (1-A) seconds (1-10 |
| | seconds) |
| EBCB | Server Block Request - Blocks client from initiating |
| | messages until it receives an EBA0 |
| EBCD | Server Disconnect - Notify Client that the Server is |
| | dropping the connection. |
| EBA0 | Tells the Sever that the Client is ready to receive data. |
| EBAY | Client requests server wait Y (1-A) or 1-10 seconds |
| EBAB | Client Block Request - Blocks server from initiating |
| | messages until it receives an EBC0. |
| EBAD | Client Disconnect - Notify Server that Client is dropping |
| | the connection. |
| ECXX | Acknowledge Client Message - Return Checksum sent by |
| | client |
| EDXX | Indicates message contains valid data field, “XX” indicates |
| | the length of the data |
| E0-9XX | User Defined |

All messages begin with the DTMF tone sequence “ITFFF” followed by one of the four-digit opcodes in TABLE B. The data field is optional, and is valid only when the four digit opcode is EDXX, where “XX” is used to specify the length of the data being sent. The maximum length is ‘FF’ to indicate a length of 255 tones for the data field. All messages end with a 2-tone checksum (2 nibbles or one byte). For the checksum, the hexadecimal values for 0×E and 0×F are represented by single tones E and F rather than dual tones (EE and EF) as in the data section of the message. This is preferred so that two tones can be used to represent the checksum rather than four tones, and to allow the checksum to be returned in only two tones in messages with opcodes EAXX and ECXX. The checksum is calculated by summing the individual nibbles (4 bits represented by a single tone) for the entire message and sending the modulo 256 result in the 2-tone or 8-bit field at the end of the message.

An exemplary message format according to the teachings of the present invention is shown in TABLE C:

TABLE C

| Start of | | Data | |
|---|---|---|---|
| Message | Opcode | (length indicated by XX) | Checksum |
| FFFF | EXXX | valid only for Opcode | 4 tones calculated by |
| | | EDXX | summing all of the |
| | | | preceding tones mod 256 |

As described in more detail below, each message sent in one direction is acknowledged with an acknowledge message sent by the receiver in the other direction. The acknowledge message includes the checksum of the message being acknowledged to provide error detection and ensure reliability.

In an embodiment of the present invention as shown in FIG. 2, client device 10 first sends a block message 30 across the connection to in-band communication server 22. The description herein contains exemplary messages described within parentheses and fields separated by commas to better illustrate the teachings of the present invention. The first message field is the start of message, second is the opcode, the third is the data field if applicable, and the fourth is the checksum. Block message (FFFF, EBAB, 6A) 30 is a request for server 22 to wait and receive data from client device 10. Server 22 then sends either an acknowledge message (FFFF, EC6A, 66) 31 or an error message if the received checksum (6A) does not match the received block message. If an error message is received by the sender, the error type may be determined and whether the message should be resent. Note that the acknowledge message echoes the checksum (6A) of block message 30 in the opcode. Client device 10, upon receiving acknowledge message 31, sends a data (FFFF, ED08, 76ADCB32, 9F) message 32. Server 2 then sends an acknowledge message (FFFF, EC9F, 6E) 33 to indicate successful receipt of data message 32. Upon receipt of acknowledge message 33, client device 10 then sends a clear block message (FFFF, EBAO, SF) 34 to allow server 22 to transmit messages now if appropriate. This clear block message from client device 10 is also acknowledged with an acknowledge message 35 from server 22. Server 22 can then send messages, for example a block client message (FFFF, EBCB, 6C) 38. Client device 10 replies with an acknowledge message (FFF, EA6C, 66) 39. Server 22, upon receipt of acknowledge message 39 from client device 10, transmits data in a data message (FFFF, EDOA, EFEE10CD95, C2) 40 to client device 10. Client device 10 then replies with an acknowledge message 41, which includes a checksum of the received data message. Either the client device or the server may send a disconnect message (FFFF, EBCD, 6E) 44 to the other party to terminate the communication session. The recipient of the disconnect message then sends an acknowledge message 45, and the communication session terminates.

It may be seen from the foregoing that a reply or acknowledge message is preferably expected for all messages to facilitate reliability and error detection. The reply can be an error message (opcode EB00-F or EB10-F), an acknowledge message (opcode EAXX or ECXX), or a disconnect message. When one party is blocked from initiating transmission of messages by the receipt of an EBCB or EBAB message, it is not blocked from sending reply or acknowledge messages.

The messaging scheme of the present invention also provides a basic level of security and authentication of the connected parties. Security and authentication may be accomplished with the exchange of pre-assigned passwords or secret codes between the client and server. For example, client device 10 may first place a call via the POTS line to server 22 and it answers. A predetermined destination address or telephone number (such as a toll free number) for the server is used to establish the connection. Client device 10 then sends a block message to server 22 to stop it from sending data and the server acknowledges the message. Client device 10 then sends a data message including a password (32 bits or 8 tones in this example) to the server. An example of the data message is shown below:

| Start of | Opcode | Data | Checksum |
|---|---|---|---|
| Message | (8-tone data to follow) | (32-bit password) | (2 tones) |
| FFFF | ED08 | 81A79BCD | A6 |

Server 22 then looks up the received password in a table, file or database and the like (not shown) using a unique client identifier for client device 10 as a key or index, for example. Unique passwords may be pre-assigned and stored for each client device expected to communicate with server 22. If a match is found, server 22 sends a message acknowledging the client message echoing the checksum of the received data message. If a match of the received password is not found, server 22 sends client device an error message or a disconnect message. Preferably, server 22 notifies the unauthenticated client that the connection is being dropped and immediately drops it by sending it the disconnect message.

If client device 10 received an acknowledge message indicating that authentication is successful, the client device sends a message indicating that it is ready to receive data (opcode EBAO). Server 22 then sends a block message to the client to stop it from sending data while the server is sending (opcode EBCB) and the client will acknowledge the message. The server next sends the client a message with a different but corresponding password stored in a table or database accessible by server. For example:

| Start of | Opcode | Data | Checksum |
|---|---|---|---|
| Message | (9-tone data to follow) | (32-bit password) | (2 tones) |
| FFFF | ED09 | 7CEF15179 | A7 |

The 32-bit password is represented by 9 tones because 0×F is represented by EF. This corresponding password may be stored in the server table or database indexable by the first password or the unique client device identifier. Client device 10 looks up in memory or another storage device (not shown) the received password sent by the server. If the client device recognizes the received password as it was previously assigned, it sends an acknowledge message back to the server and both parties are considered to have been authenticated. Otherwise, the client sends the server a disconnect message to immediately discontinue the communication session.

It may be seen from the foregoing that the present invention provides for the encoding and transmission of digital data using tones. More specifically, a POTS line may be conveniently used as a communications channel to transmit digital information using audible or inaudible in-band tones such as DTMF tones. The selection of the POTS connection and the DTMF tones takes advantage of conventional and proven technology that is widely used and accepted. Furthermore, modems and other communication devices used in today's computers and facsimile machines are not required to establish a connection and transmit the data. Therefore, the overall added cost is close to nil. The time between successive tones should be minimized to improve data transmission rates. A reasonable delay between successive tones may be 90 milliseconds if conventional POTS lines are used. The tone encoding and the messaging protocol described herein merely provide an example for implementing the teachings of the present invention as other implementations are contemplated.

While the invention has been particularly shown and described by the foregoing detailed description, it will be understood by those skilled in the art that various changes, alterations, modifications, mutations and derivations in form and detail may be made without departing from the spirit and scope of the invention.

What is claimed is:

1. A method of data communication, comprising:
generating a first series of tones, the first series of tones encoding digital data in a predetermined message format;
transmitting the first series of tones over a communication medium to a remote device; and
receiving a second series of tones, the second series of tones encoding a reply to the transmitted first series of tones in the predetermined message format.

2. The method, as set forth in claim 1, wherein generating the first series of tones comprises generating a header, an opcode, and a checksum.

3. The method, as set forth in claim 1, wherein generating the first series of tones comprises generating a header, an opcode, data, and a checksum.

4. The method, as set forth in claim 1, wherein generating the first series of tones comprises generating tones each representing a hexadecimal value.

5. The method, as set forth in claim 1, wherein receiving the second series of tones comprises receiving a checksum for the first series of tones.

6. The method, as set forth in claim 1, wherein generating the first series of tones comprises generating tones representing a first predetermined password, and receiving the second series of tones comprises receiving tones representing a second predetermined password corresponding to the first predetermined password.

7. The method, as set forth in claim 1, wherein generating the first series of tones comprises generating tones representing a first predetermined password, and receiving the second series of tones comprises receiving tones representing a disconnect message.

8. The method, as set forth in claim 1, wherein generating the first series of tones comprises generating a series of DTMF tones.

9. The method, as set forth in claim 1, wherein transmitting the first series of tones comprises transmitting over a POTS line.

10. The method, as set forth in claim 1, wherein generating the first series of tones comprises generating a series tones encoding device setup parameters for a broadband telephony device.

11. A communication method, comprising:
dialing a predetermined destination address of a remote server and waiting for a connection;
generating a first series of tones, the first series of tones encoding digital data in a predetermined message format;
transmitting the first series of tones over the connection to the remote server; and
receiving a second series of tones, the second series of tones encoding an acknowledge message, the second series of tones encoding digital data in the predetermined message format.

12. The method, as set forth in claim 11, wherein generating the first series of tones comprises generating a header, an opcode, and a checksum.

13. The method, as set forth in claim 11, wherein generating the first series of tones comprises generating a header, an opcode, data, and a checksum.

14. The method, as set forth in claim 11, wherein generating the first series of tones comprises generating tones each representing a hexadecimal value.

15. The method, as set forth in claim 11, wherein receiving the second series of tones comprises receiving a checksum for the first series of tones.

16. The method, as set forth in claim 11, wherein generating the first series of tones comprises generating tones representing a first predetermined password, and receiving the second series of tones comprises receiving tones representing a second predetermined password corresponding to the first predetermined password.

17. The method, as set forth in claim 11, wherein generating the first series of tones comprises generating tones representing a first predetermined password, and receiving the second series of tones comprises receiving tones representing a disconnect message.

18. The method, as set forth in claim 11, wherein generating the first series of tones comprises generating a series of DTMF tones.

19. The method, as set forth in claim 11, wherein transmitting the first series of tones comprises transmitting over a POTS line.

20. The method, as set forth in claim 11, further comprising:
receiving a block message from the remote server;
sending an acknowledge message to the block message to the remote server;
receiving a data message containing data from the remote server;
sending an acknowledge message to the data message to the remote server;
receiving a clear block message from the remote server; and
sending an acknowledge message to the clear block message to the remote server.

21. The method, as set forth in claim 20, further comprising sending a disconnect message to the remote server.

22. The method, as set forth in claim 20, further comprising receiving a disconnect message from the remote server.

23. A communication method, comprising:
dialing a predetermined destination address of a remote server and waiting for a POTS connection;
generating a first series of DTMF tones, the first series of DTMF tones encoding digital data in a predetermined message format having a header, an opcode, and a checksum;
transmitting the first series of DTMF tones over the POTS connection to the remote server; and
receiving a second series of DTMF tones, the second series of DTMF tones encoding an acknowledge message, the second series of DTMF tones encoding digital data in the predetermined message format.

24. The method, as set forth in claim 23, wherein generating the first series of DTMF tones comprises generating a header, an opcode, data, and a checksum.

25. The method, as set forth in claim 23, wherein generating the first series of DTMF tones comprises generating tones each representing a hexadecimal value.

26. The method, as set forth in claim 23, wherein receiving the second series of DTMF tones comprises receiving a checksum for the first series of DTMF tones.

27. The method, as set forth in claim 23, wherein generating the first series of DTMF tones comprises generating DTMF tones representing a first predetermined password, and receiving the second series of DTMF tones comprises receiving DTMF tones representing a second predetermined password related to the first predetermined password.

28. The method, as set forth in claim 23, wherein generating the first series of DTMF tones comprises generating DTMF tones representing a first predetermined password, and receiving the second series of DTMF tones comprises receiving DTMF tones representing a disconnect message.

29. The method, as set forth in claim 23, further comprising:
receiving a block message represented in DTMF tones from the remote server;
sending an acknowledge message represented in DTMF tones to the block message to the remote server;
receiving a data message represented in DTMF tones containing data from the remote server;
sending an acknowledge message represented in DTMF tones to the data message to the remote server;
receiving a clear block message represented in DTMF tones from the remote server; and
sending an acknowledge message represented in DTMF tones to the clear block message to the remote server.

30. The method, as set forth in claim 29, further comprising sending a disconnect message to the remote server.

31. The method, as set forth in claim 29, further comprising receiving a disconnect message from the remote server.
